(19) United States
(12) Patent Application Publication
(10) Pub. No.: US 2023/0306857 A1
(43) Pub. Date: Sep. 28, 2023

(54) INFORMATION PROCESSING DEVICE, INFORMATION PROCESSING METHOD, COMPUTER PROGRAM, AND MOBILE DEVICE

(71) Applicant: SONY GROUP CORPORATION, TOKYO (JP)

(72) Inventor: KOICHI HAYAKAWA, TOKYO (JP)

(21) Appl. No.: 18/041,278

(22) PCT Filed: Jun. 29, 2021
(86) PCT No.: PCT/JP2021/024615

§ 371 Date: Feb. 10, 2023

(30) Foreign Application Priority Data
Aug. 27, 2020 (JP) 2020-143293

(51) Int. Cl. G08G 5/00

(52) U.S. Cl. CPC G08G 5/0091; G08G 5/0039; G08G 5/0069; G08G 5/0013

(57) ABSTRACT

The information processing device includes: an estimation unit that estimates a wind or turbulence distribution at a predetermined altitude; and a planning unit that plans a path along which a flight vehicle flies at the predetermined altitude on the basis of the wind or turbulence distribution estimated by the estimation unit. The planning unit plans the path along which the flight vehicle flies on the basis of a wind change cost corresponding to a change in wind received at a position on the path along which the flight vehicle flies. The wind change cost includes a temporal change component of the wind and a temporal change component of the wind.

### TECHNICAL FIELD

The technology (hereinafter referred to as “present disclosure”) disclosed in the present specification relates to an information processing device, an information processing method, a computer program, and a mobile device that perform processing for planning a path for the mobile device.

### BACKGROUND ART

Mobile devices that autonomously move in an unmanned manner, such as robots or drones, are spreading. For example, drones are expected to be used in various applications such as data analysis by aerial photographing, inspection and security from the air, and delivery of articles.

When the movement of the mobile device is controlled, it is common to plan a path that avoids an obstacle. In addition, in the case of a flight vehicle, it is desirable to make a flight plan in consideration of not only obstacles such as buildings on the ground but also wind effect.

For example, a system has been proposed that generates a wind map from a result of wind measurement by a plurality of unmanned aerial vehicles and further generates a three-dimensional wind prediction map from the wind map to create a flight plan for an unmanned aerial vehicle (see Patent Document 1). Further, an unmanned aerial vehicle management device has been proposed which is provided with: a path acquisition unit that acquires a scheduled flight path of an unmanned aerial vehicle; a weather information acquisition unit that acquires weather information for specifying weather in a region including the acquired scheduled flight path at a scheduled flight time; and a flight path prediction unit that predicts an actual flight path of the unmanned aerial vehicle on the basis of the scheduled flight path and the weather information (see Patent Document 2).

A small unmanned aerial vehicle such as a drone which flies at a low altitude is small and lightweight, and thus, is more susceptible to wind than a large aircraft that flies at a high altitude.

### CITATION LIST

### Patent Document

Patent Document 1: Japanese Patent Application Laid-Open No. 2019-89538

Patent Document 2: Japanese Patent Application Laid-Open No. 2018-81675

### SUMMARY OF THE INVENTION

### Problems to be Solved by the Invention

An object of the present disclosure is to provide an information processing device, an information processing method, a computer program, and a mobile device that perform processing for planning a flight path of an aircraft that mainly flies at a low altitude.

### Solutions to Problems

The present disclosure is accomplished in view of the above problems, and a first aspect thereof provides an information processing device including:
an estimation unit that estimates a wind or turbulence distribution at a predetermined altitude; and
a planning unit that plans a path along which a flight vehicle flies at the predetermined altitude on the basis of the wind or turbulence distribution estimated by the estimation unit.

The estimation unit estimates the wind or turbulence distribution at the predetermined altitude on the basis of global wind information and a distribution of obstacles on a ground surface using a trained machine learning model.

The planning unit plans the path along which the flight vehicle flies on the basis of a wind change cost corresponding to a change in wind received at a position on the path along which the flight vehicle flies. The wind change cost includes a spatial change component of the wind (change in wind direction and wind speed) and a temporal change component of the wind (turbulence).

The planning unit plans the path on the basis of an integrated cost obtained by superimposing the wind cost and the obstacle cost. The planning unit may plan a path in which a maximum cost on the path is equal to or less than a predetermined threshold. In addition, the planning unit may plan the path along which the flight vehicle flies on the basis of a wind change cost including only the temporal change component of the wind without including the temporal change component of the wind.

In addition, a second aspect of the present disclosure provides an information processing method including:
an estimation step of estimating a wind or turbulence distribution at a predetermined altitude; and
a planning step of planning a path along which a flight vehicle flies at the predetermined altitude on the basis of the wind or turbulence distribution estimated by the estimation step.

In addition, a third aspect of the present disclosure provides a computer program described in a computer-readable format to cause a computer to function as:
an estimation unit that estimates a wind or turbulence distribution at a predetermined altitude; and
a planning unit that plans a path along which a flight vehicle flies at the predetermined altitude on the basis of the wind or turbulence distribution estimated by the estimation unit.

The computer program according to the third aspect of the present disclosure defines a computer program described in a computer readable format so as to achieve predetermined processing on a computer. In other words, by installing the computer program according to the claims of the present application in a computer, a cooperative action is exhibited on the computer, and operation and effects similar to those of the information processing device according to the first aspect of the present disclosure can be obtained.

In addition, a fourth aspect of the present disclosure provides a mobile device including:
a flying unit;
an estimation unit that estimates a wind or turbulence distribution at a predetermined altitude;
a planning unit that plans a path along which a flying object flies at the predetermined altitude on the basis of the wind or turbulence distribution estimated by the estimation unit;
a control unit that generates a command value on the basis of the path planned by the planning unit; and
a drive unit that drives the flying object on the basis of the command value generated by the control unit.

### Effects of the Invention

The present disclosure can provide an information processing device, an information processing method, a computer program, and a mobile device that plan a flight path in consideration of influences of local wind or turbulence when an aircraft flies low.

Note that the effects described in the present specification are merely examples, and the effects brought by the present disclosure are not limited thereto. Furthermore, the present disclosure may further provide additional effects in addition to the above effects.

Other objects, features, and advantages of the present disclosure will become apparent from the detailed description based on the embodiment described later and the accompanying drawings.

### BRIEF DESCRIPTION OF DRAWINGS

FIG. 1 is a diagram illustrating an example of a functional configuration of a control system 100.

FIG. 2 is a diagram illustrating an example of a functional configuration of a control system 200.

FIG. 3 is a diagram illustrating an example of an obstacle map.

FIG. 4 is a diagram in which a wind map is superimposed on the obstacle map (FIG. 3).

FIG. 5 is a diagram in which a turbulence map is superimposed on the obstacle map (FIG. 3).

FIG. 6 is a diagram illustrating a path generated using the wind map illustrated in FIG. 4.

FIG. 7 is a diagram illustrating a path generated using the turbulence map illustrated in FIG. 5.

FIG. 8 is a flowchart illustrating a processing procedure executed by the control system 200.

FIG. 9 is a diagram illustrating a state in which a turbulence is generated by a change in wind due to an influence of a structure on the ground surface.

FIG. 10 is a diagram illustrating a state in which a turbulence is generated by a change in wind due to an influence of a structure on the ground surface.

FIG. 11 is diagram illustrating an example of a small rotary-wing aircraft.

FIG. 12 illustrates a functional configuration example of a small aircraft 1200.

### MODE FOR CARRYING OUT THE INVENTION

The present disclosure will be described below in the following order with reference to the drawings.
A. Overview
B. Configuration of small aircraft
C. System configuration
C-1. Configuration example (1)
C-2. Configuration example (2)
D. Path planning considering wind and turbulence
D-1. Wind/turbulence map
D-2. Path determination method
D-3. Wind/turbulence cost
D-4. Creation of map
D-5. Creation of path
D-6. Procedure of creating path

### A. Overview

A small and lightweight unmanned aerial vehicle such as a drone is more susceptible to wind than a large aircraft. In addition, an airplane flying at a high altitude needs to make a flight plan in consideration of weather information, whereas a small unmanned aerial vehicle is assumed to fly at a low altitude, and thus needs to make a flight plan in consideration of collision avoidance with an obstacle such as undulations of the ground and buildings on the ground, wind blowing on the ground, and a spatial change and a temporal change of wind due to undulations of the ground and buildings on the ground.

The spatial change in wind is a local change in wind speed and wind direction. In addition, the temporal change in wind is a turbulence generated by irregularly turbulent fluids. A change in wind in turbulence is particularly unpredictable, and thus, it is difficult to fly a small aircraft while receiving turbulence, and cost for flying through a place with turbulence increases. In addition, compared to global wind such as seasonal wind, the wind direction of turbulence is unstable, although the wind speed thereof is small. Thus, the turbulence has a great effect on the flight of a small and lightweight unmanned aerial vehicle such as a drone.

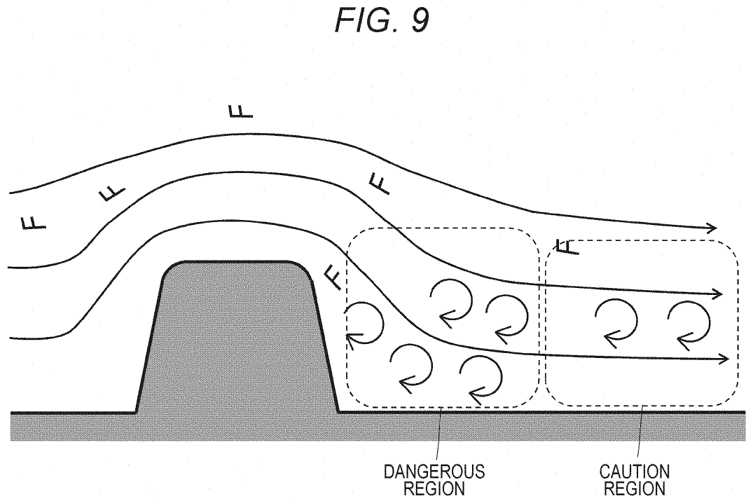

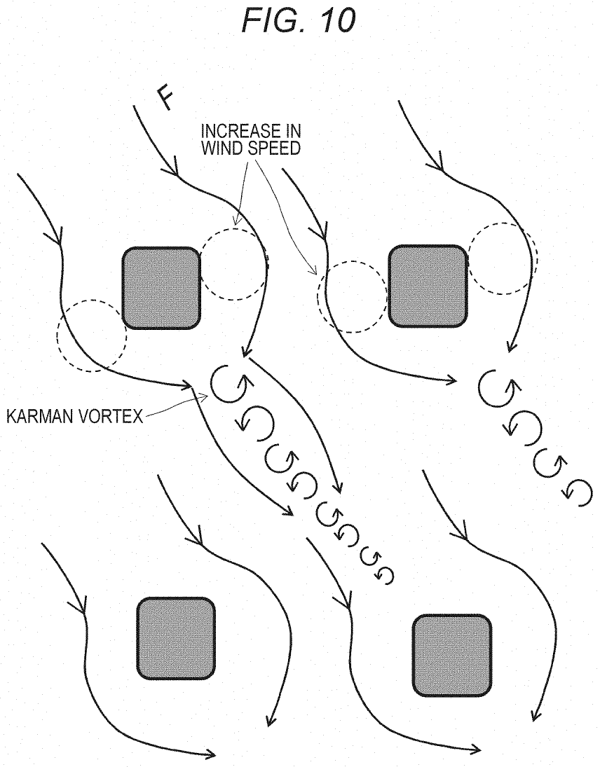

When a regularly flowing laminar flow hits an obstacle such as undulations or buildings on the ground surface, it is irregularly disturbed and turns into a turbulence. FIG. 9 illustrates wind blowing to a structure such as a building, an embankment, or a mound as viewed from side. Wind is laminar on the windward side. On the other hand, when wind hits a structure protruding from the ground surface such as a building, an embankment, or a mound, the wind speed increases immediately above the structure, and downdraft or turbulence is generated on the leeward side of the structure. Therefore, a region on the leeward side of the structure is a dangerous region where a lightweight flight vehicle such as a small unmanned aerial vehicle is likely to be caught in turbulence. In addition, FIG. 10 illustrates wind blowing to a structure such as a building or a tree as viewed from above. When wind hits the structure, the wind speed increases, and a turbulence called Karman vortex is generated on the leeward side of the structure. Therefore, a region on the leeward side of the structure is a dangerous region where a lightweight flight vehicle such as a small unmanned aerial vehicle is likely to be caught in a vortex. It is difficult for a flight vehicle to cross a dangerous region where a turbulence occurs, and it is particularly dangerous for a small aircraft such as a drone to cross such a dangerous region.

Basically, a flight vehicle is affected by wind, and a small aircraft, whether manned or unmanned, is particularly affected strongly by wind and is susceptible to turbulence during flight. In the case of manned flight, a pilot predicts a place where a change in airflow or turbulence occurs on the basis of his/her knowledge, and flies an aircraft so as to avoid such dangerous regions or respond to the change in airflow. Thus, safety flight can be achieved. On the other hand, in a case where a small aircraft is flown unmanned or on autopilot, the present disclosure estimates a region where, for example, local wind or turbulence that is likely to occur during low altitude flight occurs, and plans a low-cost flight path while avoiding such a dangerous region. Although local wind and turbulence can be calculated by numerical fluid calculation, the calculation cost is large, and it is difficult to calculate with high accuracy in real time. In view of this, the present disclosure estimates a local wind or turbulence distribution using a trained machine learning model.

Therefore, according to the present disclosure, a flight path that avoids a dangerous region where local wind or turbulence is expected is planned, and thus, a restriction of flight of a small unmanned aerial vehicle due to wind can be decreased.

As described with reference to FIGS. 9 and 10, local wind and turbulence are generated by the influence of terrain (undulations of the ground surface, buildings built on the ground, and the like). In the present disclosure, local wind and turbulence are estimated by machine learning on the basis of a global wind direction, wind speed, and terrain.

Although the global wind direction and wind speed can be acquired from, for example, weather information such as a weather forecast, measurement results by the aircraft or another aircraft may be used. Furthermore, terrain information may be a 2D image captured by a camera mounted on the aircraft, 3D terrain data acquired by a 3D camera, Lidar, or the like, 3D terrain data acquired from map information of a current location point, or the like.

### B. Configuration of Small Aircraft

Small aircrafts can be classified into fixed-wing aircrafts with fixed wings and rotary-wing aircrafts with one or more rotating wings (propellers). Although the present disclosure can be applied to both a fixed-wing aircraft and a rotary-wing aircraft, a small rotary-wing aircraft will be described here for convenience.

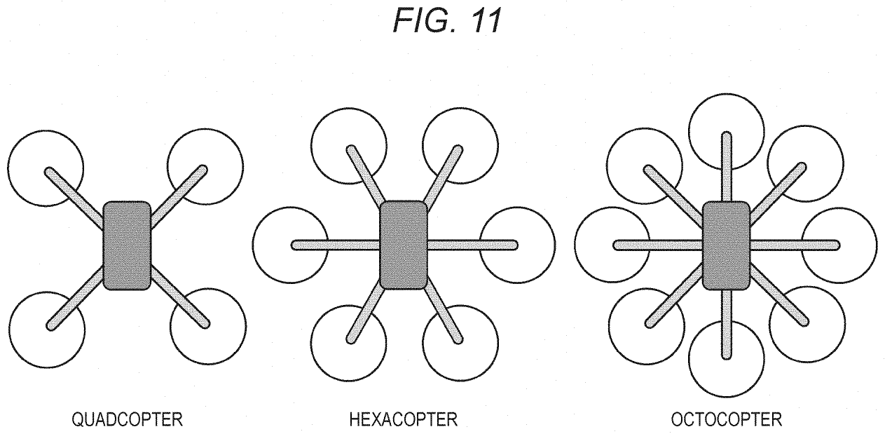

A small rotary-wing aircraft flies an airframe using lift and thrust generated by rotating a wing. A small rotary-wing aircraft can be further classified by the number of rotary wings. Examples of small rotary-wing aircraft include a quadcopter having four rotary wings, a hexacopter having six rotary wings, and an octocopter having eight rotary wings as illustrated in FIG. 11.

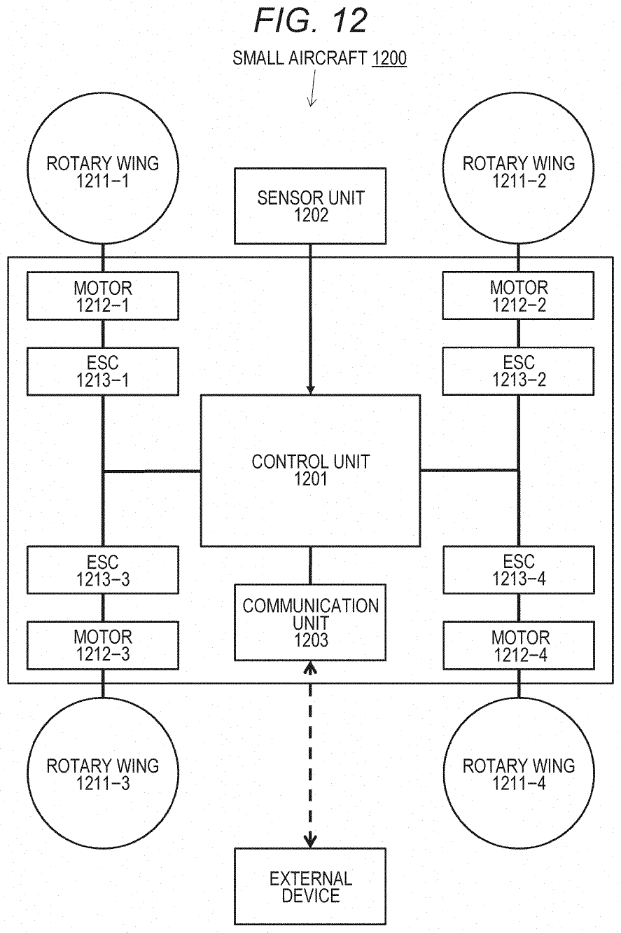

FIG. 12 illustrates a functional configuration example of a small aircraft 1200. Although FIG. 12 illustrates the configuration of a quadcopter having four rotary wings for convenience, the small aircraft 1200 can be similarly configured according to the number of rotary wings.

A control unit 1201 observes or estimates the flight environment and the flight state on the basis of sensor information from a sensor unit 1202, and calculates a command value for a power unit (described later) so as to achieve a desired operation. The control unit 1201 includes a processor such as a central processing unit (CPU) or a graphics processing unit (GPU), and a memory that loads a program to be executed by the processor and stores work data of a program execution length. The control unit 1201 corresponds to a control system described in Section C below. Alternatively, the control unit 1201 may communicate with an external control system via a communication unit 1203 to acquire information for generating a command value for the power unit from the external control system.

The power unit includes power systems based on the number of rotary wings. In the case of a hexacopter, the power unit includes four systems. One power system includes a rotary wing 1211, a motor 1212, and an electronic speed controller (ESC) 1213.

The rotary wing 1211 is rotated by the motor 1212 to generate lift and thrust of the airframe. The rotary wing 1211 has any number of blades (rotors). The blade which basically has an elongated shape has a flat shape, a bent shape, a twisted shape, a tapered shape, or a shape obtained by combining these shapes. It is assumed that the shape of the blade of the rotary wing 1211 is optimized so as to efficiently generate lift and thrust and reduce drag.

The motor 1212 rotationally drives the rotary wing 1211. In addition, the ESC 1213 can increase the lift and thrust generated by the rotary wing 1211 by increasing the number of rotations per unit time of the rotary wing 1211 by the motor 1212 that controls the drive of the motor 1212 on the basis of the command value from the control unit 1201.

It is also possible to rotate all the rotary wings 1211 in the same direction or to rotate the individual rotary wing 1211 independently. A portion of the four rotary wings 1211 rotates in one direction, and another portion rotates in the other direction. It is also possible to rotate all the rotary wings 1211 at the same rotation speed or to rotate the individual rotary wings 1211 at different rotation speeds. By controlling the four rotary wings 1211 with the four motors 1212, respectively, it is possible to generate lift and thrust and to control inclination in the roll, pitch, and yaw directions, that is, the attitude of the airframe.

The sensor unit 1202 includes a camera, a time of flight (ToF) sensor, light detection and ranging (LIDAR), a global positioning system (GPS) sensor, an inertial measurement unit (IMU), a barometric sensor, and the like.

The camera is installed to face downward so as to be able to image the ground, and obtains a still image or a moving image. It is obvious that a camera which captures images of environments in front of, behind, at the sides, and above the aircraft may be further mounted. An image or video captured by the camera is subjected to image processing, whereby it is possible to recognize undulations of the ground or a building as an object, to detect movement in the left-right direction or the horizontal direction, or to detect speed.

The ToF sensor measures a distance to an object and three-dimensional information from a time until emitted light is reflected and returned. By installing the ToF sensor on the airframe so as to face downward, the distance between the airframe and the ground can be measured, and terrains such as undulations of the ground and a shape of a building can be measured.

The LIDAR measures scattered light with respect to laser irradiation emitting pulsed light. On the basis of the measurement result of the LIDAR, the distance to the object at a long distance, the material of the object, and the like can be analyzed.

The GPS sensor receives a GPS signal from a GPS satellite to measure a current position of the small aircraft 1200 on the earth and acquire time information.

The IMU includes a three-axis gyroscope and an acceleration sensor in three directions, is installed at the center of gravity of the airframe, and measures the behavior of the airframe such as angular velocity and acceleration.

The barometric sensor measures barometric pressure. The barometric pressure changes depending on the height from the ground surface. Therefore, the altitude at which the small aircraft 1200 flies can be calculated on the basis of the barometric pressure measured by the barometric sensor.

The communication unit 1203 is equipped with a wireless communication means such as long term evolution (LTE), for example, and performs wireless communication with an external external device (for example, a remote controller device on the ground, a server device, or the like). The communication unit 1203 receives a path plan or information necessary for creating a path plan from, for example, a device on the ground, and transmits a still image, a moving image, or the like captured by the camera mounted on the airframe to the device on the ground.

Note that, in a case where the small aircraft 1200 is used for delivery of an article, a mounting portion for mounting and holding the article may be further provided. The mounting portion may have a configuration for holding a state of the article such as a position and an orientation.

### C. System Configuration

### C-1. Configuration Example (1)

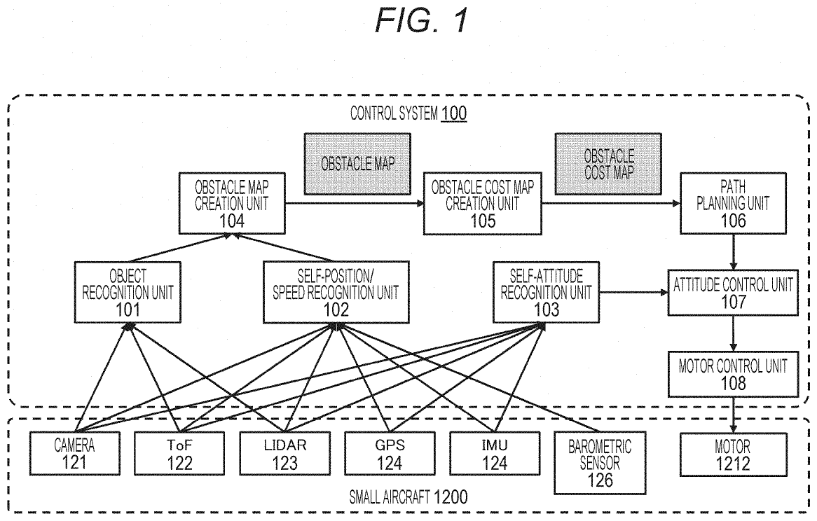

FIG. 1 schematically illustrates a functional configuration example of a control system 100 of the small aircraft 1200 that flies unmanned or on autopilot at a low altitude. In a case where the small aircraft 1200 flies at a low altitude, undulations of the ground surface, buildings, and the like are obstacles. For this reason, the control system 100 needs to create a path plan for the small aircraft 1200 so as to avoid these obstacles on the ground.

Basically, the control system 100 creates a path plan for the small aircraft on the basis of sensor information detected by sensors mounted on the small aircraft, and generates a control signal for controlling an attitude of the airframe of the small aircraft and driving of a motor that rotates a propeller on the basis of the path plan. The control system 100 may be mounted on the small aircraft, or may be a device wirelessly connected to the small aircraft and wirelessly communicate a sensor signal, a control signal, and the like with the small aircraft. Alternatively, the control system 100 may be provided by a cloud computer.

The control system 100 illustrated in FIG. 1 includes an object recognition unit 101, a self-position/speed recognition unit 102, a self-attitude recognition unit 103, an obstacle map creation unit 104, an obstacle cost map creation unit 105, a path planning unit 106, an attitude control unit 107, and a motor control unit 108. In addition, the small aircraft 1200 includes sensors for observing a flight environment and a flight state, such as a camera 121, a ToF sensor 122, a LIDAR 123, a GPS sensor 124, an IMU 125, and a barometric sensor 126, and sensor information detected by these sensors is supplied to the control system 100.

The object recognition unit 101 performs object recognition processing of recognizing undulations of the ground, buildings, and the like on the basis of sensor information from at least one of the camera 121, the ToF sensor 122, or the LIDAR 123. The object recognition unit 101 may perform object recognition using a trained machine learning model.

The self-position/speed recognition unit 102 calculates the self-position and the speed during flight of the small aircraft 1200 on the basis of sensor information from at least one of the camera 121, the ToF sensor 122, the LIDAR 123, the GPS sensor 124, the IMU 125, or the barometric sensor 126.

The self-attitude recognition unit 103 recognizes the attitude of the airframe of the small aircraft 1200 on the basis of sensor information from at least one of the ToF sensor 122, the LIDAR 123, the GPS sensor 124, or the IMU 125.

The obstacle map creation unit 104 creates an obstacle map representing a position where an obstacle that will be an obstruction when the small aircraft 1200 flies at a predetermined altitude (low altitude) is located on the basis of the result of recognizing objects on the ground by the object recognition unit 101 and the self-position and speed of the small aircraft 1200 by the self-position/speed recognition unit 102. The obstacle map creation unit 104 may create an obstacle map using a trained machine learning model. Note that the obstacle map creation unit 104 may use, as the information regarding obstacles on the ground, map information instead of the result of recognizing objects on the ground by the object recognition unit 101.

The obstacle cost map creation unit 105 creates an obstacle cost map on the basis of the obstacle map created by the obstacle map creation unit 104. When flying at a low altitude in a region where there is an obstacle such as an undulation of the ground or a building, the small aircraft 1200 raises the flight altitude or takes a detour route in order to avoid collision with the obstacle. This generates a cost such as extra energy as compared with a case where the small aircraft passes through an area without an obstacle. Such a cost is referred to as an obstacle cost. The obstacle cost map is a map representing the obstacle cost for each region.

The path planning unit 106 refers to the obstacle cost map created by the obstacle cost map creation unit 105 to plan a path along which the small aircraft 1200 flies from the current position to the destination. For example, in a case where the obstacle costs of all the regions are uniform, the path planning unit 106 plans the shortest flight path connecting the current position of the small aircraft 1200 and the destination. On the other hand, in a case where there is a variation in the obstacle cost for each region, the path planning unit 106 plans a flight path by which the small aircraft 1200 can reach the destination from the current position at the lowest cost.

The attitude control unit 107 generates a command value for controlling the attitude of the airframe on the basis of the attitude of the small aircraft 1200 recognized by the self-attitude recognition unit 103 and the flight path of the small aircraft 1200 planned by the path planning unit 106.

The motor control unit 108 generates a command value for controlling driving of each motor 1212 that rotates the corresponding rotary wing 1211 of the small aircraft 1200. By controlling the four rotary wings 1211 with the four motors 1212, respectively, it is possible to generate lift and thrust and to control inclination in the roll, pitch, and yaw directions, that is, the attitude of the airframe (as described above). The motor control unit 108 generates a command value for each motor 1212 according to the command value of the attitude generated by the attitude control unit 107 and outputs the command value to each ESC 1211 so that the small aircraft 1200 flies along the flight path planned by the path planning unit 106.

### C-2. Configuration Example (2)

At a low altitude, turbulence or downdraft is generated when wind blowing on the ground surface hits a structure. In a case where the small aircraft 1200 flies at a low altitude, the small aircraft may be caught in turbulence or downdraft to lose attitude stability of the airframe, and may collide with an obstacle or crash. For this reason, when creating the path plan for the small aircraft 1200, it is necessary to consider not only obstacles such as undulations of the ground or buildings but also wind blowing on the ground surface, and further an influence of changes in wind speed and wind direction and a turbulence generated due to the undulations of the ground and buildings.

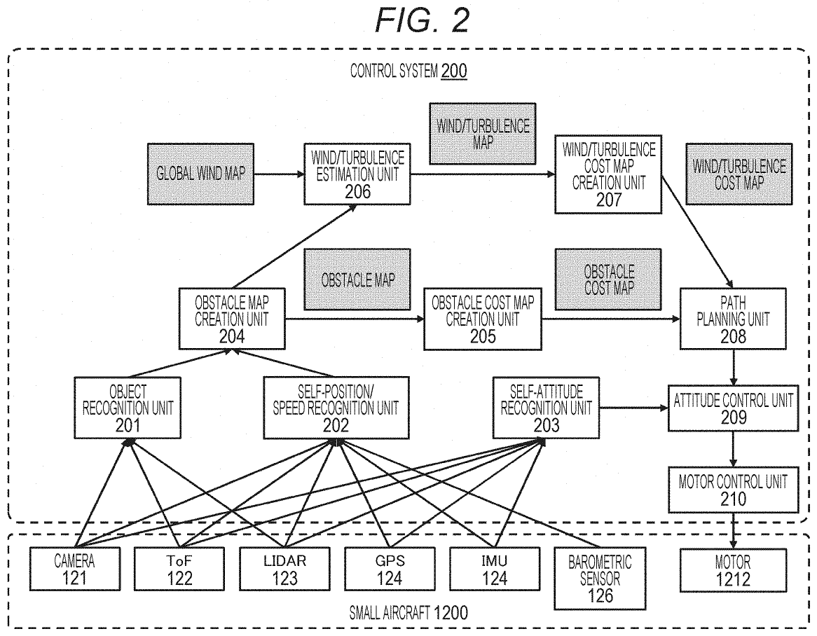

FIG. 2 illustrates an example of functional configuration of a control system 200 that creates a path plan for the small aircraft 1200 in further consideration of wind and turbulence due to the influence of structures on the ground. The control system 200 may be mounted on the small aircraft, or may be a device wirelessly connected to the small aircraft 1200 and wirelessly communicate a sensor signal, a control signal, and the like with the small aircraft 1200. Alternatively, the control system 200 may be provided by a cloud computer.

The control system 200 illustrated in FIG. 2 includes an object recognition unit 201, a self-position/speed recognition unit 202, a self-attitude recognition unit 203, an obstacle map creation unit 204, an obstacle cost map creation unit 205, a wind/turbulence estimation unit 206, a wind/turbulence cost map creation unit 207, a path planning unit 208, an attitude control unit 209, and a motor control unit 210. In addition, the small aircraft 1200 includes sensors for observing a flight environment and a flight state, such as a camera 121, a ToF sensor 122, a LIDAR 123, a GPS sensor 124, an IMU 125, and a barometric sensor 126, and sensor information detected by these sensors is supplied to the control system 100.

The object recognition unit 201 performs object recognition processing of recognizing undulations of the ground, buildings, and the like on the basis of sensor information from at least one of the camera 121, the ToF sensor 122, or the LIDAR 123. The self-position/speed recognition unit 202 calculates the self-position and the speed during flight of the small aircraft 1200 on the basis of sensor information from at least one of the camera 121, the ToF sensor 122, the LIDAR 123, the GPS sensor 124, the IMU 125, or the barometric sensor 126. The self-attitude recognition unit 203 recognizes the attitude of the airframe of the small aircraft 1200 on the basis of sensor information from at least one of the ToF sensor 122, the LIDAR 123, the GPS sensor 124, or the IMU 125.

The obstacle map creation unit 204 creates an obstacle map representing a position where an obstacle that will be an obstruction when the small aircraft 1200 flies at a predetermined altitude (low altitude) is located on the basis of the result of recognizing objects on the ground by the object recognition unit 201 and the self-position and speed of the small aircraft 1200 by the self-position/speed recognition unit 202. The obstacle cost map creation unit 205 creates an obstacle cost map on the basis of the obstacle map created by the obstacle map creation unit 204.

The wind/turbulence estimation unit 206 estimates distribution of local wind and turbulence generated at a flight altitude (low altitude) of the small aircraft 1200 on the basis of a global wind direction, wind speed, and terrain, and creates a wind/turbulence map. The wind/turbulence estimation unit 206 creates a wind/turbulence map in which a change in wind speed and wind direction and turbulence as shown in, for example, FIGS. 9 and 10 are expressed in 2D or 3D. The wind/turbulence estimation unit 206 estimates a local wind or turbulence distribution using a trained machine learning model. Although it is obvious that the wind/turbulence estimation unit 206 calculates local wind and turbulence by numerical fluid calculation, the calculation cost is large, and it is difficult to calculate with high accuracy in real time.

Note that the wind/turbulence estimation unit 206 uses the obstacle map created by the obstacle map creation unit 204 as terrain information. In addition, the wind/turbulence estimation unit 206 can acquire the global wind direction and wind speed from a global wind map based on weather information such as a weather forecast, for example. Alternatively, the wind/turbulence estimation unit 206 may utilize wind information measured by the sensor unit 1202 of the small aircraft 1200 or another aircraft.

The wind/turbulence cost map creation unit 207 creates a wind/turbulence cost map on the basis of the wind/turbulence map created by the wind/turbulence estimation unit 206. At low altitudes, wind speed and wind direction change due to undulations of the ground and structures such as buildings, and local wind and turbulence that cannot be directly derived from the global wind map are generated. In the wind/turbulence cost map, the difficulty of flight that is higher than that when the small aircraft 1200 passes through a region where there is no change in wind speed or wind direction or turbulence due to the influence of local wind or turbulence at a low altitude is referred to as wind/turbulence cost. The wind/turbulence cost map is a map representing the wind/turbulence cost for each region.

The path planning unit 208 superimposes the obstacle cost map created by the obstacle cost map creation unit 205 on the wind/turbulence cost map created by the wind/turbulence cost map creation unit 207 to plan a path along which the small aircraft 1200 flies from the current position to the destination at a predetermined flight altitude (low altitude). For example, in a case where a plurality of path candidates is planned and the cost obtained by superimposing the obstacle cost and the wind/turbulence cost of each candidate is uniform, the path planning unit 208 plans the shortest flight path connecting the current position of the small aircraft 1200 and the destination. On the other hand, in a case where there is a variation in cost obtained by superimposing the wind/turbulence cost and the obstacle cost of each candidate, the path planning unit 208 selects a flight path by which the small aircraft 1200 can reach at the lowest cost as the best path. For example, the path planning unit 208 may plan the flight path on the basis of an integrated cost obtained by simply adding or performing weighted summation on the obstacle cost and the wind/turbulence cost for each region.

The attitude control unit 209 generates a command value for controlling the attitude of the airframe on the basis of the attitude of the small aircraft 1200 recognized by the self-attitude recognition unit 203 and the flight path of the small aircraft 1200 planned by the path planning unit 208.

The motor control unit 210 generates a command value for each motor 1212 according to the command value of the attitude generated by the attitude control unit 209 and outputs the command value to each ESC 1211 so that the small aircraft 1200 flies along the flight path planned by the path planning unit 208. The motor control unit 210 controls the motors 1212 that rotate the rotary wings 1211 of the small aircraft 1200, respectively, thereby being capable of generating lift and thrust and controlling inclination in the roll, pitch, and yaw directions, that is, the attitude of the airframe.

D. Path planning considering wind and turbulence This section will describe path planning of the small aircraft 1200 by the control system 200 illustrated in FIG. 2 in consideration of wind and turbulence at a low altitude.

### D-1. Wind/Turbulence Map

The above section C has described an example in which the wind/turbulence estimation unit 206 in the control system 200 estimates the wind/turbulence map representing the distribution of local wind and turbulence generated at a low altitude on the basis of the global wind direction and wind speed and terrain using the machine learning model. It is obvious that, similar to the weather forecast, the wind/turbulence map may be provided from the outside (for example, a site on the Internet).

In the present disclosure, the wind/turbulence map is a map on which xyz components of the wind speed and the turbulence at any place r (x, y, z) in the space where the small aircraft 1200 flies are described. The xyz component of the wind speed w is (wₓ, w_{y}, w_{z}). In addition, the turbulence is a flow in which the wind speed, the wind direction, and the like irregularly fluctuate. In the present disclosure, a turbulence is defined as a standard deviation σ_{w} of a wind speed from a time average. Therefore, strictly speaking, the wind/turbulence map is a map in which six amounts are described, the six amounts being obtained by adding turbulences represented by standard deviations (σₓ, σ_{y}, σ_{z}) from a time average for each of xyz components of the wind speed to xyz components (wₓ, w_{y}, w_{z}) of the wind speed w. However, since it is difficult to calculate turbulences, the wind/turbulence map may describe turbulences using two components (σₕ, σᵥ) in the horizontal and vertical directions or a single value σ obtained by averaging (or performing weighted average on) all variances of the xyz components. In the above definition, the turbulence is a deviation from the average, so that the average value of turbulence components is 0.

### D-2. Path Determination Method

Aircrafts flying in midair are susceptible to wind. In addition, at a low altitude, turbulence in which the wind speed and the wind direction irregularly change is likely to occur due to an influence of the terrain of the ground. For this reason, a small aircraft flying at a low altitude is likely to be affected by turbulence. Therefore, it is desirable to determine the flight path of the aircraft on the basis of, for example, the following rules (1) to (8).
(1) Avoid a place where airflow is disturbed (Pass through upstream side of disturbance as much as possible).
(2) Keep a sufficient distance from an obstacle or the ground surface in a case of passing through a place where airflow is disturbed.
(3) Avoid a place where downdraft occurs.
(4) When wind suddenly changes on the path, accelerate the airframe in advance in the direction in which wind suddenly changes to prevent the aircraft from moving downwind.
(5) Fly in a place where there is wind (tailwind) blowing in a traveling direction along the path.
(6) Fly in a place where there is a weak updraft with less turbulence.
(7) At the time of landing, land on a place with less disturbance while facing wind.
(8) Select a path with less vibration (select a path with small changes in wind speed and wind direction, and in a case where a change in wind speed and wind direction is expected to be great, decrease speed).

When a small aircraft passes through a region where wind changes spatially or temporally, an external force is applied to the airframe, and the attitude is disturbed. When the attitude of the airframe is greatly disturbed, it becomes difficult to control the airframe, which causes deviation from the planned path or crash. Even if the deviation from the path or the crash does not occur, the field of view of the camera mounted on the airframe is greatly disturbed, and thus, a person viewing the captured image of the camera may become sick (for example, may have motion sickness).

In view of this, the control system 200 according to the present disclosure introduces a cost function for calculating a cost (wind/turbulence cost) representing a flight difficulty level due to an influence of local wind and turbulence in order to plan a flight path along which the small aircraft flies in consideration of local wind and turbulence that are likely to occur during low altitude flight. That is, the wind/turbulence cost map creation unit 207 creates a wind/turbulence cost map representing the wind/turbulence cost for each region from the wind/turbulence map. Then, the path planning unit 208 superimposes the wind/turbulence cost map on the obstacle cost map to plan a flight path of the small aircraft. As a result, the path planning unit 208 can plan a path when the small aircraft flies at a low altitude in consideration of the influence of wind as well as avoidance of obstacles on the ground. In addition, the path planning unit 208 can plan a path along which even a small aircraft can fly safely by avoiding not only a region where strong wind blows but also a region where the wind speed and the wind direction locally change greatly and a region where turbulence occurs, on the basis of the wind/turbulence cost map representing the distribution of wind or turbulence.

### D-3. Wind/Turbulence Cost

Assume that a planned path for the small aircraft 1200 to be controlled by the control system 200 is p(t). p(t) is a vector including the position and the moving direction of the airframe at time t. Further, wind at the position (x, y, z) is W(x, y, z). W(x, y, z) can be acquired as an observation result by a sensor mounted on the small aircraft 1200 or external information such as a weather forecast. The wind W(x, y, z) is a vector including the wind speed and the wind direction at the corresponding position (x, y, z). The wind at the position p(t) on the planned path at time t is represented by W(p(t)). A temporal change of the wind W(p(t)) applied to the airframe of the small aircraft 1200 is expressed by following Expression (1).

$$\begin{matrix}Expression 1 & \\ \frac{d \vec{W} ( \vec{p} ( t ) )}{dt} = \frac{\partial \vec{W}}{\partial \vec{r}} ( \vec{p} ( t ) ) \cdot \frac{d \vec{p}}{dt} ( t ) + \frac{\partial \vec{W}}{\partial t} ( \vec{p} ( t ) ) & ( 1 )\end{matrix}$$

In Expression (1), dp(t)/dt is a temporal change of the airframe, that is, the airframe speed, and thus, when it is expressed as v(t), following Expression (2) is obtained.

$$\begin{matrix}Expression 2 & \\ \frac{d \vec{W} ( \vec{p} ( t ) )}{dt} = \frac{\partial \vec{W}}{\partial \vec{r}} ( \vec{p} ( t ) ) \cdot \vec{v} ( t ) + \frac{\partial \vec{W}}{\partial t} ( \vec{p} ( t ) ) & ( 2 )\end{matrix}$$

The wind/turbulence map can be expressed on the basis of above Expression (2). Referring to above Expression (2), the temporal change of the wind W(p(t)) received by the flying airframe is expressed by the sum of the product of the spatial change of the wind W and the airframe speed v in the first term on the right-hand side and the temporal change of the wind W itself in the second term on the right-hand side. The temporal change of the wind W itself in the second term on the right-hand side is turbulence, and has a random variable. Therefore, from an expected value and a variance, a cost function CW representing the influence of the change in wind on the airframe differs depending on the airframe (or shape and weight of the airframe). Therefore, it is difficult to handle the cost function CW. Thus, the cost function can be expressed as following Expression (3) in consideration of the distribution of turbulence after the second-order Taylor expansion is performed.

$$\begin{matrix}Expression 3 & \\ C W ( \frac{d \vec{W} ( \vec{p} ( t ) )}{dt} ) = \vec{A} \cdot \frac{\partial \vec{W}}{\partial \vec{r}} ( \vec{p} ( t ) ) \cdot \vec{v} ( t ) + {k}_{1} \vec{A} \cdot {Var ( \frac{\partial \vec{W}}{\partial t} ( \vec{p} ( t ) ) )}^{\frac{1}{2}} + {\vert B \frac{\partial \vec{W}}{\partial t} ( \vec{p} ( t ) ) \cdot \vec{v} ( t ) \vert}^{2} + {k}_{2} \text{} {\vert \text{} B Var ( \frac{\partial \vec{W}}{\partial t} ( \vec{p} ( t ) ) ) \vert}^{2} & ( 3 )\end{matrix}$$

In above Expression (3), A is a characteristic vector that determines the primary response of the airframe, B is a characteristic vector that determines the secondary response, and k1 and k2 are assumed deviation values of the primary and secondary turbulences, respectively. Var(x) is a parameter that takes a variance of the random variable x. The wind/turbulence cost map can be calculated from the wind/turbulence map by transformation into Expression (3). When the variance is represented by o, above Expression (3) can be transformed into following Expression (4).

$$\begin{matrix}Expression 4 & \\ CW ( \frac{d \vec{W} ( \vec{p} ( t ) )}{dt} ) = \vec{A} \cdot \frac{\partial \vec{W}}{\partial \vec{r}} ( \vec{p} ( t ) ) \cdot \vec{v} ( t ) + {k}_{1} \vec{A} \cdot \vec{σ} ( \vec{p} ( t ) ) + {\vert B \frac{\partial \vec{W}}{\partial t} ( \vec{p} ( t ) ) \cdot \vec{v} ( t ) \vert}^{2} + {k}_{2} {\vert B \vec{σ} ( \vec{p} ( t ) ) \vert}^{2} & ( 4 )\end{matrix}$$

The wind/turbulence cost map can be expressed on the basis of above Expression (4). The first term on the right-hand side of above Expression (4) represents the influence of the change in wind at the position p(t) of the airframe at time t, and the second term on the right-hand side represents the influence of turbulence. In addition, the third term on the right-hand side is the square term of the influence of the change in wind, and the fourth term on the right-hand side is the square term of the influence of turbulence.

The path planning unit 208 plans a path along which the small aircraft can safely fly by avoiding obstacles on the ground and avoiding a region where the wind speed and the wind direction locally change greatly and a region where turbulence occurs from a cost function obtained by superimposing the wind/turbulence cost CW(p(t)) calculated by above Expression (4) and the obstacle cost CD(p(t)) calculated on the basis of the obstacle on the ground.

The cost of the path is obtained by integrating the cost function obtained by superimposing the wind/turbulence cost CW(p(t)) and the obstacle cost CD(p(t)) by the path. In a case where the path planning unit 208 plans a plurality of path candidates from the current position to the destination, a path with the lowest cost among the plurality of path candidates is the best path.

Furthermore, the path planning unit 208 may set a predetermined threshold for the cost and plan the path so that the maximum cost on the path does not exceed the threshold. For example, the maximum value of shake of the airframe can be defined by defining the maximum value of the wind/turbulence cost. Referring to above Expression (4), the first term on the right-hand side is the product of a spatial change of the wind W and the airframe speed v, in other words, it is proportional to the airframe speed v(t). Therefore, the path planning unit 208 can reduce the maximum value of the shake of the airframe by reducing the airframe speed v(t) at a point where the spatial change of the wind is large.

The cost function indicated by above Expression (4) includes both the wind cost of the first term on the right-hand side and the turbulence cost of the second term on the right-hand side. Therefore, the path plan based on above Expression (4) can be considered to be a path plan using both the wind cost map and the turbulence cost map. On the other hand, the path planning unit 208 may perform path planning using only the wind cost map that does not include the turbulence cost. It is to be noted, however, that, in this case, the path planning unit 208 may also perform path planning by superimposing the wind cost map and the obstacle cost map.

In a case where the path planning unit 208 performs path planning using only the wind cost map, the wind/turbulence cost map creation unit 207 is only required to calculate the wind cost on the basis of following Expression (5). In this case, the wind/turbulence estimation unit 206 does not need to estimate the turbulence map, whereby a calculation load is reduced.

$$\begin{matrix}Expression 5 & \\ C W ( \frac{d \vec{W} ( \vec{p} ( t ) )}{dt} ) = \vec{A} \cdot \frac{\partial \vec{W}}{\partial \vec{r}} ( \vec{p} ( t ) ) \cdot \vec{v} ( t ) + {\vert B \frac{\partial \vec{W}}{\partial t} ( \vec{p} ( t ) ) \cdot \vec{v} ( t ) \vert}^{2} & ( 5 )\end{matrix}$$

### D-4. Creation of Map

This section will describe each map created by the control system 200 to plan the flight path of the small aircraft 1200.

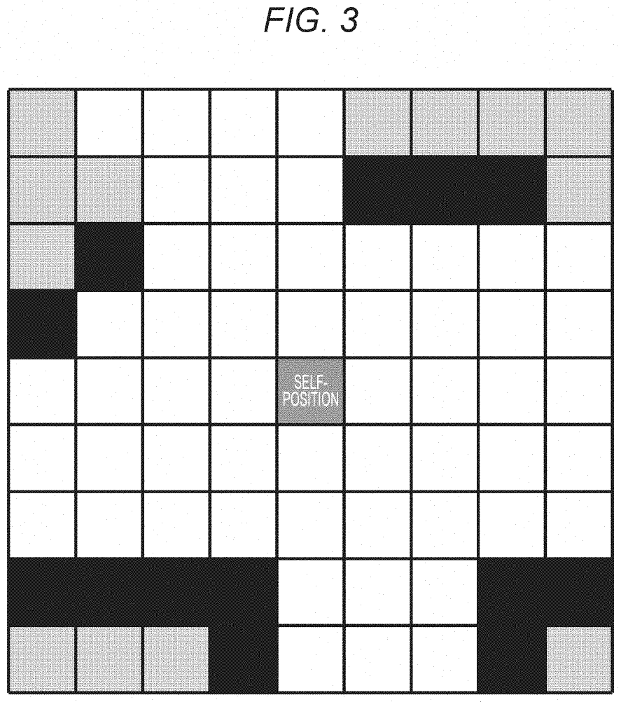

FIG. 3 illustrates an example of the obstacle map created by the obstacle map creation unit 204. As described in Section C-2 above, the obstacle map creation unit 204 creates an obstacle map representing a position where an obstacle that will be an obstruction when the small aircraft 1200 flies at a predetermined altitude (low altitude) is located on the basis of the result of recognizing objects on the ground by the object recognition unit 201 and the self-position and speed of the small aircraft 1200 by the self-position/speed recognition unit 202. The obstacle map illustrated in FIG. 3 illustrates a situation of an obstacle for each region divided in a grid pattern. Specifically, a central region is defined as the self-position of the small aircraft 1200, regions where obstacles are present are filled with black, regions where the small aircraft 1200 can fly are filled with light gray, and unobserved (or unrecognizable) regions are filled with dark gray. The obstacle cost increases in the order of light gray, dark gray, and black. In the example illustrated in FIG. 3, each region is represented by any one of three types of states (that is, three types of obstacle costs), but an obstacle cost map using four or more types of states may be used. In addition, the size (that is, the granularity of the obstacle cost map) of the grid may be further reduced as necessary.

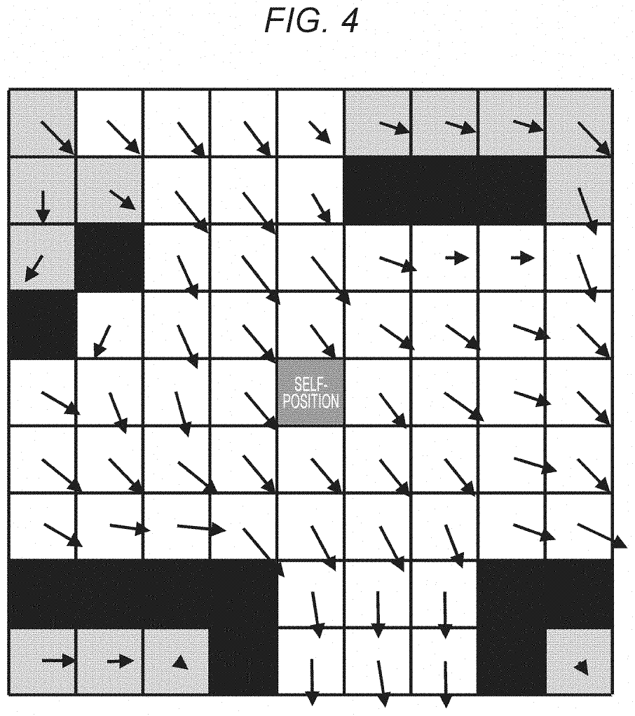

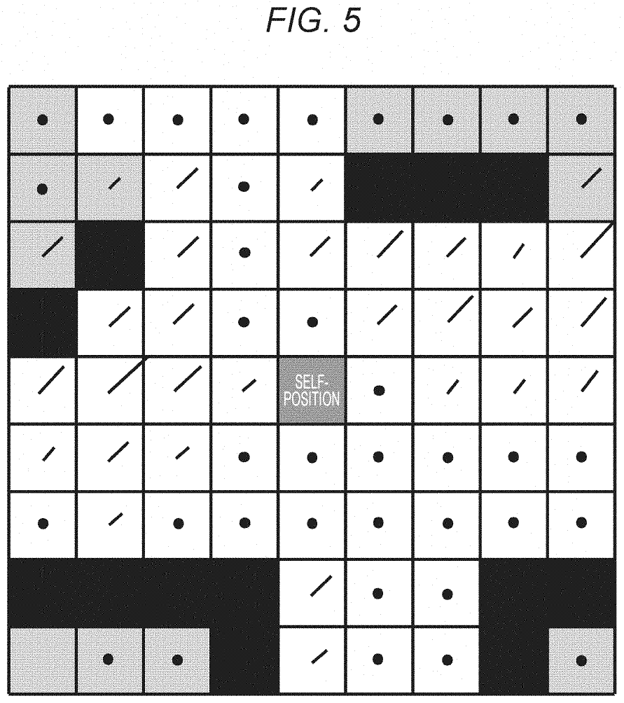

As described in Section C-2 above, the wind/turbulence estimation unit 206 estimates wind and turbulence on the basis of the global wind direction and wind speed and the obstacle map created by the obstacle cost map creation unit 204, and creates a wind map and a turbulence map. FIG. 4 illustrates the wind map that is created by the wind/turbulence estimation unit 206 and is superimposed on the obstacle cost map illustrated in FIG. 3. The wind map illustrated in FIG. 4 shows estimation results of the wind direction and the wind speed in each region divided in a grid pattern (a direction of an arrow in FIG. 4 represents wind light, and a length of the arrow represents wind speed). In addition, FIG. 5 illustrates the turbulence map that is created by the wind/turbulence estimation unit 206 and is superimposed on the obstacle cost map illustrated in FIG. 3. In the present disclosure, the turbulence is defined as a standard deviation of the wind speed from the time average in each region (as described above). In the turbulence map shown in FIG. 5, the ventral deviation value in each region is represented by the length of an oblique line. In a region where no turbulence occurs, the length of the oblique line is zero, and this is represented by a point drawn at the center of the region.

### D-5. Creation of Path

As described in Section C-2 above, the path planning unit 208 superimposes the obstacle cost map created by the obstacle cost map creation unit 205 on the wind/turbulence cost map created by the wind/turbulence cost map creation unit 207 to plan a flight path along which the small aircraft 1200 flies from the current position to the destination at a predetermined flight altitude (low altitude).

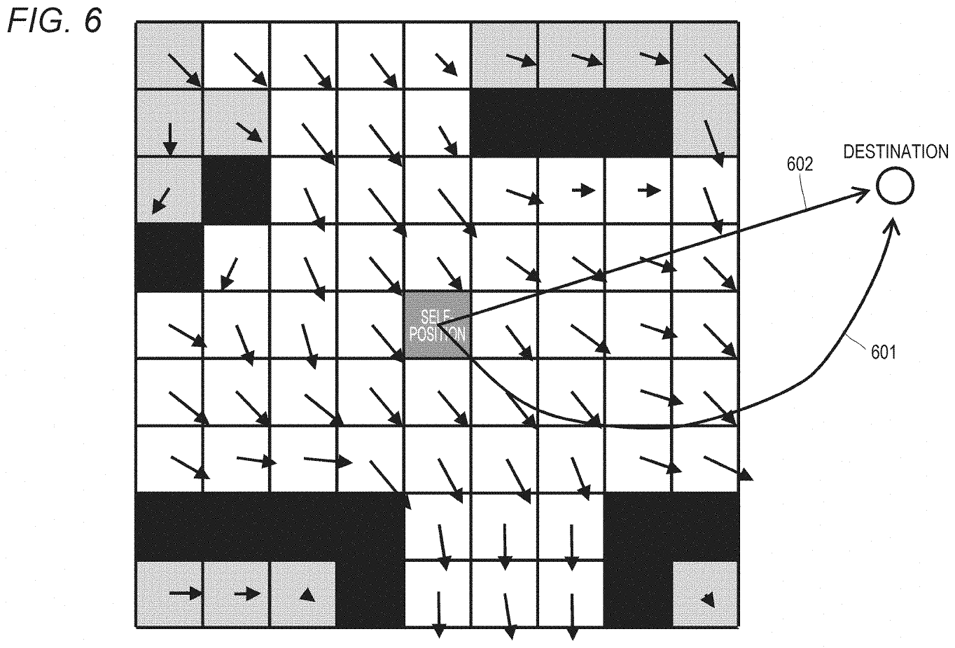

FIG. 6 illustrates a flight path 601 from the current self-position to the destination generated by the path planning unit 208 using the wind map illustrated in FIG. 4. The wind map illustrated in FIG. 4 is superimposed on the obstacle map (as described above). FIG. 6 also illustrates, as comparison, a flight path 602 generated by the path planning unit 208 using only obstacles.

In a case where the path planning unit 208 plans a flight path of the small aircraft 1200 using only the obstacle map illustrated in FIG. 3, the path planning unit 208 generates the shortest flight path that linearly connects the self-position of the small aircraft 1200 and the destination as indicated by reference sign 602 in consideration of only avoidance of the obstacle. However, since the path 602 is not generated in consideration of the wind direction and the wind speed on the path, the path includes a place where the airframe receives wind on the side, and the airframe may greatly shake when passing through such a place or the small aircraft 1200 may consume fuel in order to fly along the path 602.

As described in Section D-2 above, the airframe can be moved with the flow of wind at low fuel cost while maintaining the attitude stability of the airframe when a place having wind (tailwind) blowing in the traveling direction along the path is selected. The path planning unit 208 plans a flight path of the small aircraft 1200 using the wind map illustrated in FIG. 4, thereby generating a path 601 that passes through a place having wind (tailwind) blowing in the traveling direction along the path and that gives less shake, although the path 601 deviates from the shortest path connecting the self-position of the small aircraft 1200 and the destination.

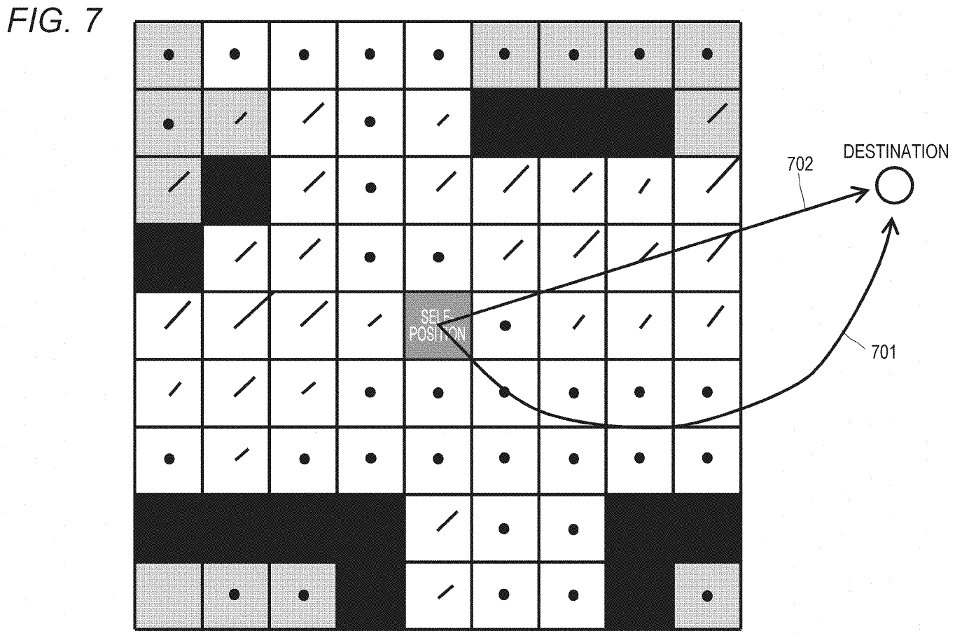

FIG. 7 illustrates a flight path 701 from the current self-position to the destination generated by the path planning unit 208 using the turbulence map illustrated in FIG. 5. The turbulence map illustrated in FIG. 5 is superimposed on the obstacle map (as described above). FIG. 6 also illustrates, as comparison, a flight path 702 generated by the path planning unit 208 using only obstacles.

The shortest flight path linearly connecting the self-position of the small aircraft 1200 and the destination as indicated by reference sign 702 is not generated in consideration of a temporal change of wind such as turbulence, and thus, the path includes a place where airflow is disturbed, and the small aircraft 1200 does not keep enough distance from an obstacle or the ground surface when passing through such a place. Therefore, when the airframe greatly shakes due to the disturbance of airflow, the airframe may collide with the obstacle or the ground surface. In addition, compared to global wind such as seasonal wind, the wind direction of turbulence is unstable, although the wind speed thereof is small. Thus, the turbulence has a great effect on the flight of a small and lightweight unmanned aerial vehicle such as a drone.

The path planning unit 208 plans a flight path of the small aircraft 1200 using the turbulence map illustrated in FIG. 5, thereby generating a path 701 that avoids a place where the airflow is disturbed and that gives less shake as described in Section D-2, although the path 701 deviates from the shortest path connecting the self-position of the small aircraft 1200 and the destination. Therefore, the small aircraft 1200 can maintain the attitude stability with less shake of the airframe by flying along the path 701. In addition, a sufficient distance is kept from an obstacle or the ground surface in a case where the small aircraft 1200 passes through a place where the airflow is disturbed in the path 701.

### D-6. Procedure of Creating Path

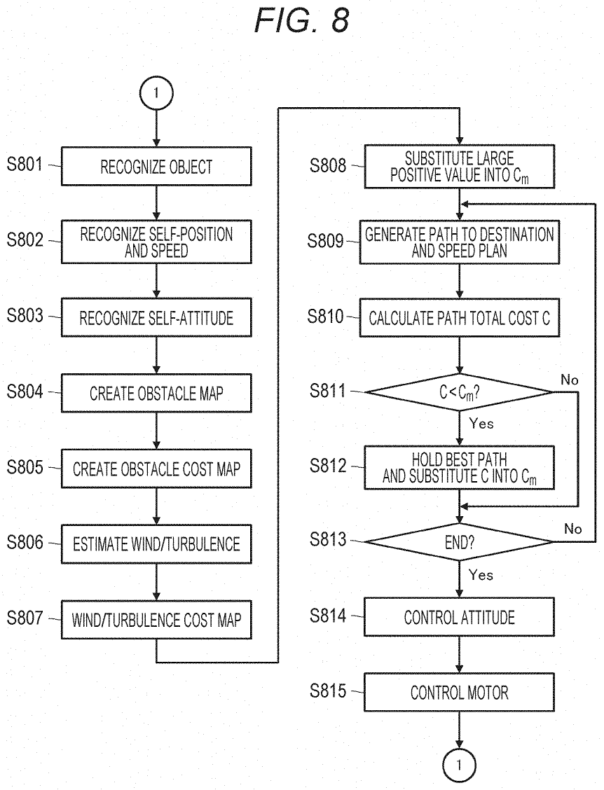

FIG. 8 illustrates, in the form of a flowchart, a processing procedure of creating a path plan in consideration of wind and turbulence due to an influence of structures on the ground surface and controlling the small aircraft 1200 by the control system 200.

The object recognition unit 201 performs object recognition processing of recognizing undulations of the ground, buildings, and the like on the basis of sensor information from at least one of the camera 121, the ToF sensor 122, or the LIDAR 123 (step S801).

Next, the self-position/speed recognition unit 202 calculates the self-position and the speed during flight of the small aircraft 1200 on the basis of sensor information from at least one of the camera 121, the ToF sensor 122, the LIDAR 123, the GPS sensor 124, the IMU 125, or the barometric sensor 126 (step S802).

Next, the self-attitude recognition unit 203 recognizes the attitude of the airframe of the small aircraft 1200 on the basis of sensor information from at least one of the ToF sensor 122, the LIDAR 123, the GPS sensor 124, or the IMU 125 (step S803).

Next, the obstacle map creation unit 204 creates an obstacle map representing a position where an obstacle that will be an obstruction when the small aircraft 1200 flies at a predetermined altitude (low altitude) is located on the basis of the result of recognizing objects on the ground by the object recognition unit 201 and the self-position and speed of the small aircraft 1200 by the self-position/speed recognition unit 202 (step S804).

Next, the obstacle cost map creation unit 205 creates an obstacle cost map on the basis of the obstacle map created by the obstacle map creation unit 204 (step S805).

Next, the wind/turbulence estimation unit 206 estimates distribution of local wind W(p(t)) generated at a flight altitude (low altitude) of the small aircraft 1200 on the basis of a global wind direction, wind speed, and terrain, and creates a wind/turbulence map on the basis of Expression (2) above (step S806).

Next, a wind/turbulence cost map is created from the wind/turbulence map created by the wind/turbulence estimation unit 206 on the basis of Expression (4) described above (step S807).

Here, a large positive value is substituted into the total cost Cₘ of the best path (step S808).

Then, the path planning unit 208 performs processing of superimposing the obstacle cost map created by the obstacle cost map creation unit 205 on the wind/turbulence cost map created by the wind/turbulence cost map creation unit 207 to plan a flight path along which the small aircraft 1200 flies from the current position to the destination at a predetermined flight altitude (low altitude).

First, the path planning unit 208 generates a path to the destination and a speed plan on the path (step S809).

Then, the path planning unit 208 superimposes the obstacle cost obtained from the obstacle cost map and the wind/turbulence cost obtained from the wind/turbulence cost map on each other (performing addition or weighted summation) when the path and the speed plan generated in step S809 are implemented, and calculates a path total cost C (step S810).

Next, the best path total cost Cₘ is compared with the path total cost C calculated in step S810 (step S811). Then, if the path total cost C is smaller than the best path total cost Cₘ (Yes in step S811), the path generated in step S809 is held as the currently best path, and the value of the path total cost C is substituted into the best path total cost Cₘ (step S812).

A path generation loop including steps S809 to S812 is repeatedly executed until a predetermined end condition is satisfied (No in step S813). The end condition is, for example, an allowable time of the path searching process. It is also obvious that other end conditions may be set, such as finding a path in which the total cost is equal to or less than a predetermined value.

The attitude control unit 209 generates a command value for controlling the attitude of the airframe on the basis of the attitude of the small aircraft 1200 recognized by the self-attitude recognition unit 203 and the flight path of the small aircraft 1200 planned by the path planning unit 208 (step S814).

The motor control unit 210 generates a command value for each motor 1212 according to the command value of the attitude generated by the attitude control unit 209 and outputs the command value to each ESC 1211 so that the small aircraft 1200 flies along the flight path planned by the path planning unit 208 (step S815). The motor control unit 210 controls the motors 1212 that rotate the rotary wings 1211 of the small aircraft 1200, respectively, thereby generating lift and thrust and controlling inclination in the roll, pitch, and yaw directions, that is, the attitude of the airframe.

The control system 200 repeatedly executes the above processing while the small aircraft 1200 is flying.

### INDUSTRIAL APPLICABILITY

The present disclosure has been described above in detail with reference to the specific embodiment. However, it is obvious that those skilled in the art can modify or substitute the embodiment without departing from the scope of the present disclosure.

The present specification has mainly described the embodiment in which the present disclosure is applied to a case where a small and lightweight unmanned aerial vehicle such as a drone flies at a low altitude, but the gist of the present disclosure is not limited thereto. The present disclosure can be similarly applied to a case where a small aircraft flies in various modes such as a case where a small aircraft, whether unmanned or manned, flies, a case where an aircraft, whether small or large, flies at a low altitude, and a case where a small aircraft flies low or high. Thus, the present disclosure enables low-cost flight by avoiding danger due to an influence of wind.

In short, the present disclosure has been described in an illustrative manner, and the contents described in the present specification should not be interpreted in a limited manner. In order to determine the gist of the present disclosure, the scope of claims should be taken into consideration.

It is to be noted that the present disclosure may have the following configurations.
(1) An information processing device including:
an estimation unit that estimates a wind or turbulence distribution at a predetermined altitude; and
a planning unit that plans a path along which a flight vehicle flies at the predetermined altitude on the basis of the wind or turbulence distribution estimated by the estimation unit.
(2) The information processing device according to (1), in which
the estimation unit estimates the wind or turbulence distribution at the predetermined altitude on the basis of global wind information and a distribution of obstacles on a ground surface.
(3) The information processing device according to (1) or (2), in which
the estimation unit estimates the wind or turbulence distribution at the predetermined altitude using a trained machine learning model.
(4) The information processing device according to any one of (1) to (3), in which
the planning unit plans the path along which the flight vehicle flies on the basis of a wind change cost corresponding to a change in wind received at a position on the path along which the flight vehicle flies.
(5) The information processing device according to (4), in which
the wind change cost includes a spatial change component of the wind and a temporal change component of the wind.
(6) The information processing device according to (4) or (5), in which
the planning unit plans the path in further consideration of an obstacle cost according to a distribution of obstacles on a ground surface.
(7) The information processing device according to (6), in which
the planning unit plans the path on the basis of an integrated cost obtained by superimposing the wind cost and the obstacle cost.
(8) The information processing device according to any one of (4) to (7), in which
the planning unit plans a path in which a maximum cost on the path is equal to or less than a predetermined threshold.
(9) The information processing device according to any one of (4) to (8), in which
the planning unit plans the path along which the flight vehicle flies on the basis of a wind change cost including only the temporal change component of the wind without including the temporal change component of the wind.
(10) The information processing device according to any one of (1) to (9), further including
a control unit that generates a command value for the flight vehicle on the basis of the path planned by the planning unit.
(11) An information processing method including:
an estimation step of estimating a wind or turbulence distribution at a predetermined altitude; and
a planning step of planning a path along which a flight vehicle flies at the predetermined altitude on the basis of the wind or turbulence distribution estimated by the estimation step.

(12) A computer program described in a computer-readable format to cause a computer to function as:
an estimation unit that estimates a wind or turbulence distribution at a predetermined altitude; and
a planning unit that plans a path along which a flight vehicle flies at the predetermined altitude on the basis of the wind or turbulence distribution estimated by the estimation unit.
(13) A mobile device including:
a flying unit;
an estimation unit that estimates a wind or turbulence distribution at a predetermined altitude;

a planning unit that plans a path along which a flying object flies at the predetermined altitude on the basis of the wind or turbulence distribution estimated by the estimation unit;

a control unit that generates a command value on the basis of the path planned by the planning unit; and
a drive unit that drives the flying object on the basis of the command value generated by the control unit.

### REFERENCE SIGNS LIST

100 Control system
101 Object recognition unit
102 Self-position/speed recognition unit
103 Self-attitude recognition unit
104 Obstacle map creation unit
105 Obstacle cost map creation unit
106 Path planning unit
107 Attitude control unit
108 Motor control unit
121 Camera
122 ToF sensor
123 LIDAR
124 GPS sensor
125 IMU
126 Barometric sensor
200 Control system
201 Object recognition unit
202 Self-position/speed recognition unit
203 Self-attitude recognition unit
204 Obstacle map creation unit
205 Obstacle cost map creation unit
206 Wind/turbulence estimation unit
207 Wind/turbulence cost map creation unit
208 Path planning unit
209 Attitude control unit
210 Motor control unit
1200 Small aircraft
1201 Control unit
1202 Sensor unit
1203 Communication unit
1211 Rotary wing
1212 Motor
1213 ESC

1. An information processing device comprising:
an estimation unit that estimates a wind or turbulence distribution at a predetermined altitude; and
a planning unit that plans a path along which a flight vehicle flies at the predetermined altitude on a basis of the wind or turbulence distribution estimated by the estimation unit.

2. The information processing device according to claim 1, wherein
the estimation unit estimates the wind or turbulence distribution at the predetermined altitude on a basis of global wind information and a distribution of obstacles on a ground surface.

3. The information processing device according to claim 1, wherein
the estimation unit estimates the wind or turbulence distribution at the predetermined altitude using a trained machine learning model.

4. The information processing device according to claim 1, wherein
the planning unit plans the path along which the flight vehicle flies on a basis of a wind change cost corresponding to a change in wind received at a position on the path along which the flight vehicle flies.

5. The information processing device according to claim 4, wherein
the wind change cost includes a spatial change component of the wind and a temporal change component of the wind.

6. The information processing device according to claim 4, wherein
the planning unit plans the path in further consideration of an obstacle cost according to a distribution of obstacles on a ground surface.

7. The information processing device according to claim 6, wherein
the planning unit plans the path on a basis of an integrated cost obtained by superimposing the wind cost and the obstacle cost.

8. The information processing device according to claim 4, wherein
the planning unit plans a path in which a maximum cost on the path is equal to or less than a predetermined threshold.

9. The information processing device according to claim 4, wherein
the planning unit plans the path along which the flight vehicle flies on a basis of a wind change cost including only the temporal change component of the wind without including the temporal change component of the wind.

10. The information processing device according to claim 1, further comprising
a control unit that generates a command value for the flight vehicle on a basis of the path planned by the planning unit.

11. An information processing method comprising:
an estimation step of estimating a wind or turbulence distribution at a predetermined altitude; and
a planning step of planning a path along which a flight vehicle flies at the predetermined altitude on a basis of the wind or turbulence distribution estimated by the estimation step.

12. A computer program described in a computer-readable format to cause a computer to function as:
an estimation unit that estimates a wind or turbulence distribution at a predetermined altitude; and
a planning unit that plans a path along which a flight vehicle flies at the predetermined altitude on a basis of the wind or turbulence distribution estimated by the estimation unit.

13. A mobile device comprising:
a flying unit;
an estimation unit that estimates a wind or turbulence distribution at a predetermined altitude;
a planning unit that plans a path along which a flying object flies at the predetermined altitude on a basis of the wind or turbulence distribution estimated by the estimation unit;
a control unit that generates a command value on a basis of the path planned by the planning unit; and
a drive unit that drives the flying object on a basis of the command value generated by the control unit.
